(19) United States
(12) Patent Application Publication
(10) Pub. No.: US 2019/0154948 A1
(43) Pub. Date: May 23, 2019

(54) SIDE VERTICAL MIRROR GROUP AND INSTALLATION METHOD THEREOF

(71) Applicant: SHANGHAI MICRO ELECTRONICS EQUIPMENT (GROUP) CO., LTD., Shanghai (CN)

(72) Inventors: Mingtian WANG, Shanghai (CN); Guogan LIU, Shanghai (CN)

(21) Appl. No.: 16/097,522

(22) PCT Filed: Apr. 28, 2017
(86) PCT No.: PCT/CN2017/082498

§ 371 Date: Oct. 29, 2018

(30) Foreign Application Priority Data
Apr. 29, 2016 (CN) 201610285798.8

(51) Int. Cl. G02B 7/02

(52) U.S. Cl. CPC G02B 7/026; G02B 7/025

(57) ABSTRACT

A vertically-oriented lens assembly is disclosed which includes: a lens frame (1); an optical lens (2); two rigid supports (7) that are symmetric to each other with respect to a vertical central axis of the lens frame (1), both integral with the lens frame (1), and both in direct contact with the optical lens (2); an elastic support (4) disposed right under the optical lens (2) and brought into contact with the optical lens (2) by an adjusting screw (10); and a tightening screw (8) disposed on the top of the lens frame (1) for limiting radial displacement of the optical lens (2). A method for forming the vertically-oriented lens assembly is also disclosed, including: disposing the optical lens (2) on a rigid supporting member (5) of the lens frame (1) so that the optical lens (2) is vertically oriented; applying a force to the optical lens (2) via the tightening screw (8) to make the rigid supports (7) both abut the optical lens (2); adjusting a supporting force provided by the elastic support (4) to the optical lens (2) by the adjusting screw (10); attaching pre-tensioning spring leaf (6) and dispensing an adhesive through bores (3) to fixedly attach the optical lens (2) to the lens frame (1); and attaching an axial stop block (11), allowing high stability and a high surface precision and it can be used in engineering applications.

### TECHNICAL FIELD

The present invention relates to a lens assembly and, in particular, to a vertically-oriented lens assembly and a method of installing the lens assembly.

### BACKGROUND

Processing and manufacturing of high-precision optical lens is a very complex process. Nowadays, complexity of optical systems and the numbers of optical components therein are increasing with market requirements on their imaging quality becoming more and more demanding. Currently, such optical components are required to be positioned with a precision on the order of microns and to maintain a surface precision of tens of nanometers.

A catadioptric system typically has both vertical and horizontal optical axes. That is, there are both horizontally and vertically oriented optical components in the system, which are subject to rather different gravitational effects. For an optical component with a large diameter (usually >200 mm), gravitational effects cannot be ignored. The fixation methods need to consider the gravitational effects, so that the methods applicable for horizontally-oriented fixation is no longer applicable to the vertically-oriented fixation. For example, horizontally-oriented fixation of such an optical component is usually accomplished simply by applying an adhesive along its outer periphery and bonding it to a lens frame. However, when this approach is used in its vertically-oriented fixation, surface variations, usually of several hundred nanometers, may be resulted.

A common method for vertically fixing an optical component is to use a V-shaped fixture with two horizontally symmetric bottom supports, which function like two arms of a V-shaped block, and one top safety stopper. In this method, when loaded, most of the optical component's gravity is concentrated on the two lower supports, tending to concentrate stress and cause relatively significant surface variations. Since the stress generated on the lens resulting from the fixation method will directly impact the surface consistency of the lens, a stress-free fixation method is often used to obtain a high surface accuracy.

Another conventional method for vertically fixing an optical component in a stress-free manner is a strip fixation method. The optical component is supported on a strip at a lower portion of its outer circumference. Due to the flexible nature of the strip, the load distribution is uniform and the optical component experiences less surface variations. However, such an assembly is vulnerable to transportation, vibration and other harsh conditions. This method is more suitable for experimental rather than engineering applications.

In still another conventional method for vertically fixing an optical component in a stress-free manner, the optical component is supported on multiple elastic members, and radial loads for each of the elastic members may be calculated to minimize surface variations of the optical component. However, in practice, as this assembly is created horizontally and used vertically, eccentricity and tilt control of the optical component is difficult. In addition, arranging the elastic members is also a tedious process. For these reasons, this method is also suitable for experimental rather than engineering applications.

### SUMMARY OF THE INVENTION

In order to overcome the above deficiencies, it is an objective of the present invention to provide a reliable, surface-consistent vertically-oriented lens assembly suitable for use in engineering applications.

To this end, the subject matter of the present invention lies in a vertically-oriented lens assembly, including: a lens frame oriented vertically and an optical lens retained vertically in the lens frame, the vertically-oriented lens assembly further includes: two rigid supports that are symmetric to each other with respect to a vertical central axis of the lens frame, both integral with the lens frame, both disposed under a horizontal central axis of the lens frame and both in direct contact with the optical lens; an elastic support right under the optical lens, the elastic support being able to be brought into contact with the optical lens through adjustment of an adjusting screw penetrating through the lens frame from right under a bottom of the lens frame; and a tightening screw disposed right at a top of the lens frame for limiting a radial displacement of the optical lens.

Additionally, in the vertically-oriented lens assembly, the optical lens may be fixedly attached to the lens frame by an adhesive dispensed from bores that penetrate through the lens frame, the bores being symmetrically distributed on both sides of the vertical central axis of the lens frame and arranged above the horizontal central axis of the lens frame.

Additionally, in the vertically-oriented lens assembly, two bores may be present on both sides of the vertical central axis of the lens frame, and wherein the two bores are oriented with respect to each other at an angle ranging from 30° to 170°.

Additionally, in the vertically-oriented lens assembly, the two rigid supports may be symmetrically distributed on both sides of the vertical central axis of the lens frame and are oriented with respect to each other at an angle ranging from 30° to 120°.

Additionally, the vertically-oriented lens assembly may further include a clamping support mechanism for offsetting an axial displacement of the optical lens.

Additionally, in the vertically-oriented lens assembly, the clamping support mechanism may include at least one pre-tensioning spring leaf and a rigid supporting member disposed on each side of a bottom of the optical lens.

Additionally, in the vertically-oriented lens assembly, the clamping support mechanism may further include an adjusting spacer disposed between the optical lens and the pre-tensioning spring leaf.

Additionally, in the vertically-oriented lens assembly, an axial stop block for limiting the axial displacement of the optical lens may be provided on a side of the pre-tensioning spring leaf facing away from the optical lens.

Additionally, in the vertically-oriented lens assembly, the rigid supporting member may be disposed on one side right under the lens frame.

In the vertically-oriented lens assembly of this embodiment, under the action of a force equal in magnitude to the gravity of the vertically-oriented optical lens retained within the lens frame is exerted through the atop tightening screw, the optical lens abuts both the rigid supports distributed in symmetry on both sides of the vertical central axis of the lens frame. As a result, the gravity of the optical lens is dispersed, with the tightening screw serving as a rigid stopper to limit radial displacement of the optical lens, thus ensuring stability of the optical lens within the lens frame and hence surface consistency of the vertically-oriented lens assembly. Moreover, the tightening screw can prevent eccentricity of the optical lens under transportation, vibration or other conditions, which can degrade the precision of the lens assembly. Further, the lens frame is so fabricated that the two rigid supports integral therewith maintain a desired relative positional relationship with respect to a center of the inner circle of the lens frame, allowing the optical lens to be fast assembled with the lens frame without a clearance therebetween. As a result, the vertically-oriented lens assembly of the present invention has an improved precision. Furthermore, the support provided by the elastic support to the optical lens can be adjusted by changing its degree of compression. Since the elastic support comes into direct contact with the optical lens, it serves as a third support which cooperates with the two rigid supports to balance the gravity of the optical lens. In other words, the gravitational load is distributed and dispersed among these three supports, thus balancing and stabilizing the optical lens. Therefore, the present invention entails a vertically-oriented lens assembly with a high surface precision. The present invention is applicable to catadioptric objective lenses. Compared to the conventional assembly utilizing an inverted V-shaped fixture, the assembly of the present invention has more force-bearing points that are more dispersed. As a result, each of the force-bearing points is subject to a reduced load, thus avoiding the problem of load concentration. In addition, the assembly of the present invention is more stable more the conventional strip-based assembly. Further, in comparison with the conventional assembly using multiple elastic members, the assembly of the present invention is simpler in structure and enables a higher degree of load dispersion. For these reasons, the vertically-oriented lens assembly of the present invention is more suitable for engineering applications.

The above object is also attained by a method for forming the vertically-oriented lens assembly as defined above, including the steps of:

S1) vertically orienting a lens frame;

S2) vertically disposing an optical lens on rigid supports of the lens frame;

S3) applying a force that equals a magnitude of gravity of the optical lens to the optical lens via a tightening screw, making each of the rigid supports abut the optical lens to limit a radial displacement of the optical lens;

S4) adjusting, with aid of a force gauge, a supporting force provided by an elastic support, such that the elastic support supports the optical lens with a supporting force equal in magnitude to ⅓ the gravity of the optical lens, and then locking an adjusting screw;

S5) attaching at least one pre-tensioning spring leaf, measuring a tension force produced by the at least one pre-tensioning spring leaf and making the tension force equal in magnitude to ⅔ the gravity of the optical lens;

S6) dispensing an adhesive through bores to fixedly attach the optical lens to the lens frame; and

S7) attaching an axial stop block.

Additionally, the method for installing the vertically-oriented lens assembly may further include a step S8) of adhesively fixing the adjusting screw and the tightening screw, thereby preventing loosening of the adjusting screw and/or the tightening screw.

Additionally, the method for installing the vertically-oriented lens assembly may, further include a step of selecting the elastic support according to the gravity of the optical lens to ensure sufficient supporting force and compressibility of the elastic support, so that the gravity of the optical lens is evenly distributed on the two rigid supports and the elastic support.

Additionally, the method for installing the vertically-oriented lens assembly may further include a step of polishing an adjusting spacer and disposing the adjusting spacer between the optical lens and the pre-tensioning spring leaf in order to adjust the tension force provided by the pre-tensioning spring leaf.

In the above method of the present invention, the tightening screw exerts a force to limit radial displacement of the optical lens, and the supporting force provided by the elastic support to the optical lens can be easily adjusted by changing the degree of compression of the elastic support. In addition, the optical lens is fixed to the lens frame by the adhesive dispensed from the bores. For these reasons, the resulting vertically-oriented lens assembly has guaranteed stability. Further, the clamping support mechanism can limit axial displacement of the optical lens. In this way, the vertically-oriented lens assembly is kept stable both axially and radially and thus has a guaranteed surface precision.

### BRIEF DESCRIPTION OF THE DRAWINGS

FIG. 1 is schematic view of a vertically-oriented lens assembly according to an embodiment of the present invention.

FIG. 2 is a cross-sectional view of a vertically-oriented lens assembly according to an embodiment of the present invention.

FIG. 3 is an enlarged view of portion II of FIG. 2.

FIG. 4 is a cross-sectional view taken along line A-A in FIG. 2.

FIG. 5 is an enlarged view of portion I of FIG. 4.

FIG. 6 shows data of a simulation experiment on surface variations that a lens will experience under the effect of its own gravity in an unassembled configuration.

FIG. 7 shows data of a simulation experiment on minimum surface variations that the lens will experience under the effect of its own gravity when it is assembled in accordance with the present invention.

FIG. 8 shows data of a simulation experiment on maximum surface variations that the lens will experience under the effect of its own gravity when it is assembled in accordance with the present invention.

In these figures: 1—lens frame; 2—optical lens; 3—bore for dispensing an adhesive; 4—elastic support; 5—rigid supporting member; 6—pre-tensioning spring leaf; 7—rigid support; 8—tightening screw; 9—adjusting spacer; 10—adjusting screw; 11—axial stop block; G—gravitational direction.

### DETAILED DESCRIPTION OF PREFERRED EMBODIMENTS

The invention will now be described in detail below with reference to the accompanying drawings. As used herein, the term “vertically-oriented” means orientations that are vertical or substantially vertical. With optical lenses as an example, a vertically-oriented lens refers to such a lens that has an optical axis extending horizontally or substantially horizontally.

### Embodiment 1

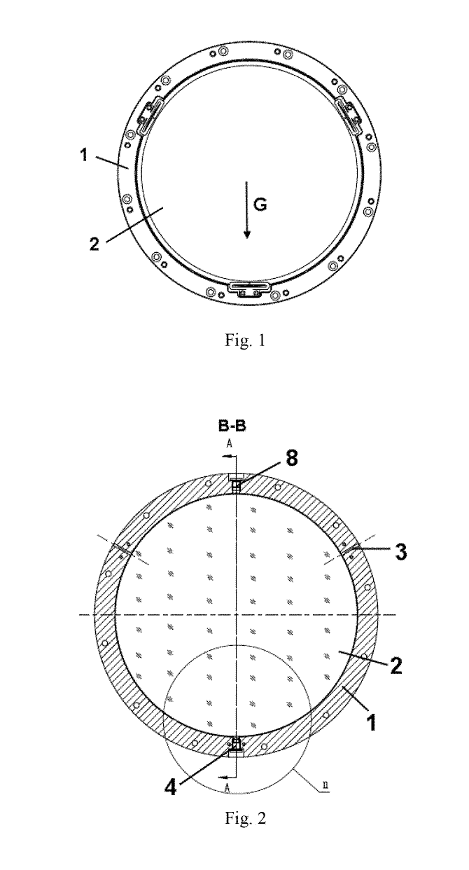

Referring now to FIGS. 1 to 5, a vertically-oriented lens assembly according to this embodiment includes: a lens frame 1 which is oriented vertically; an optical lens 2 surrounded and retained vertically by the lens frame 1; two rigid supports 7 that are symmetric to each other with respect to a vertical central axis of the lens frame 1, both integral with the lens frame 1, wherein the rigid supports 7 are both under a horizontal central axis of the lens frame 1 and the rigid supports 7 are both in direct contact with the optical lens 2; an elastic support 4 right under the optical lens 2, the elastic support 4 is able to be brought into contact with the optical lens 2 through adjustment of an adjusting screw 10 penetrating through the lens frame 1 from right under a bottom of the lens frame; and a tightening screw 8 is disposed right at a top of the lens frame 1 for limiting radial displacement of the optical lens 2.

In the vertically-oriented lens assembly according to this embodiment, the optical lens 2 is vertically retained within the lens frame 1. Under the action of a force equal in magnitude to the gravity G of the vertically-oriented optical lens 2 is exerted through the tightening screw 8 penetrating downward through the lens frame 1 at the top thereof, the optical lens 2 abuts both the rigid supports 7 distributed in symmetry on both sides of the vertical central axis of the lens frame 1. As a result, the gravity G of the optical lens 2 is divided between the two rigid supports on which the optical lens 2 is compressed on, with the tightening screw 8 serving as a rigid stopper to limit radial displacement of the optical lens 2, ensuring stability of the optical lens 2 within the lens frame 1 and hence surface consistency of the vertically-oriented lens assembly. Moreover, the tightening screw 8 can prevent eccentricity of the optical lens 2 under transportation, vibration or other conditions, which can degrade the precision of the lens assembly. Further, the lens frame 1 is so fabricated that the two rigid supports 7 integral therewith maintain a desired relative positional relationship with respect to a center of the inner circle of the lens frame 1, allowing the optical lens 2 to be fast assembled with the lens frame 1 without a clearance between the optical lens 2 and the lens frame 1. As a result, the vertically-oriented lens assembly of the present invention has an improved precision. Furthermore, the support provided by the elastic support 4 to the optical lens 2 can be adjusted by changing the degree of compression of the elastic support 4. Since the elastic support 4 comes into direct contact with the optical lens 2, the elastic support 4 serves as a third support which cooperates with the two rigid supports 7 to balance the gravity of the optical lens 2. In other words, the gravitational load is distributed and dispersed among these three supports, thus balancing and stabilizing the optical lens 2. Therefore, this embodiment of the present invention entails a vertically-oriented lens assembly with a high surface precision.

Referring to FIG. 2, the optical lens 2 may be fixedly attached to the lens frame 1 by an adhesive dispensed from bores 3. The bores 3 penetrate through the lens frame 1 and are distributed in symmetry with respect to the vertical central axis of the lens frame 1 and are arranged above the horizontal central axis of the lens frame 1. In this embodiment, there are two bores 3 oriented at an angle of 30°-170°. For example, the two bores 3 are oriented at an angle of 120°. The adhesive dispensed from the bores 3 only fixes the optical lens 2 to the lens frame 1 and does not exert any force on the optical lens 2. Moreover, when the optical lens 2 is thermally expanded, an optical axis of the optical lens 2 tends to shift upward. At this point, the adhesive dispensed from the bores 3 located symmetrically on both sides of the vertical central axis of the lens frame 1 above the horizontal central axis thereof can absorb forces generated from the thermal expansion of the optical lens 2, maintaining the surface consistency and precision of the vertically-oriented lens assembly. According to the present invention, with the symmetric design of both the bores 3 and the rigid supports 7 above and under the horizontal central axis of the lens frame 1, the vertically-oriented lens assembly gains significantly improved overall stability.

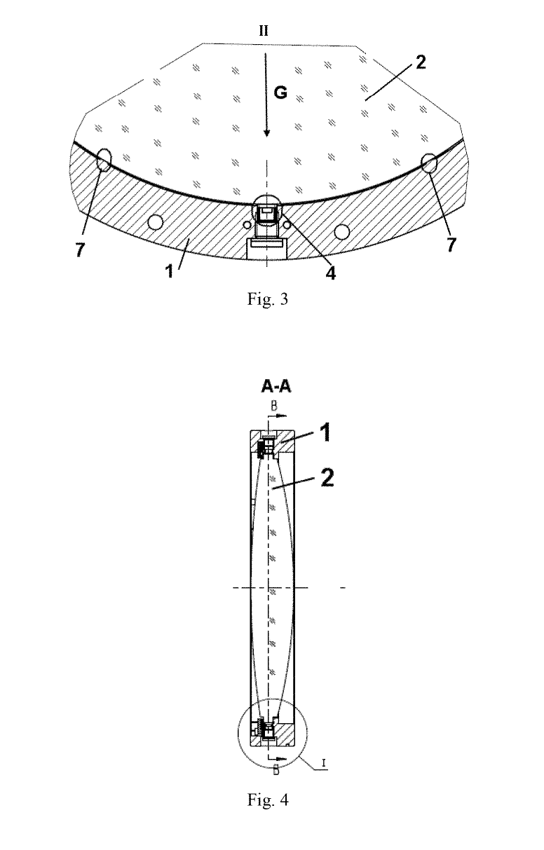

Referring to FIG. 3, in the vertically-oriented lens assembly according to this embodiment, in order to disperse the gravity G of the optical lens 2 to insure the stability of the vertically-oriented lens assembly, the two rigid support 7 on both sides of the vertical central axis of the lens frame 1 may be symmetrically oriented at an angle of 30°-120°, e.g., 30° with respect to each other.

Referring to FIG. 5, the vertically-oriented lens assembly according to this embodiment may further include a clamping support mechanism for offsetting any axial displacement of the optical lens 2. The clamping support mechanism includes at least one pre-tensioning spring leaf 6 abutting a vertical side surface of a bottom protrusion of the optical lens 2. The pre-tensioning spring leaf 6 is opposing a rigid supporting member 5 abutting an opposite vertical side surface of the bottom protrusion. Thus, the rigid supporting member 5 is disposed on one side, e.g., the left or right side, right under the lens frame 1. According to this embodiment, there may be three (without limitation) pre-tensioning spring leaves 6 for axial fixation of the optical lens 2. When the optical lens 2 is subject to an axial impact, the elasticity of the pre-tensioning spring leaves 6 can restore the position of the optical lens 2 without any clearance generated, ensuring the surface consistency and precision of the vertically-oriented lens assembly. The number of the pre-tensioning spring leaves 6 may vary based on practical needs. According to this embodiment, the clamping support mechanism may preferably further include an adjusting spacer 9 disposed between the optical lens 2 and the pre-tensioning spring leaves 6. The adjusting spacer 9 may be polished to adjust the tension provided by the pre-tensioning spring leaves 6, thereby allowing improved axial stability of the vertically-oriented lens assembly and effectively-controlled surface precision of the optical lens 2.

According to this embodiment, an axial stop block 11 for limit axial displacement of the optical lens 2 may be disposed external to the pre-tensioning spring leaves 6. Moreover, the axial stop block 11 may also be able to secure the pre-tensioning spring leaf 6.

### Embodiment 2

In this embodiment, there is provided a method for making the vertically-oriented lens assembly of Embodiment 1. The method includes the steps of:

S1) vertically orienting the lens frame 1;

S2) vertically disposing the optical lens 2 on the rigid supporting member 5 of the lens frame 1;

S3) applying a force to the optical lens 2 via the tightening screw 8, the force is equal in magnitude to the gravity G of the optical lens 2, making each of the rigid supports 7 abut the optical lens 2 to limit radial displacement of the optical lens;

S4) adjusting, with aid of a force gauge, a supporting force provided by the elastic support 4, such that the elastic support supports the optical lens 2 with a supporting force equal in magnitude to ⅓ the gravity G of the optical lens 2, and then locking an adjusting screw 10;

S5) attaching one or more pre-tensioning spring leaves 6 based on the practical need, measuring a tension force produced by the pre-tensioning spring leaves 6 and making the tension force equal in magnitude to ⅔ the gravity G of the optical lens 2;

S6) dispensing the adhesive through the bores 3 to fixedly attach the optical lens 2 to the lens frame 1; and

S7) attaching the axial stop block 11. For example, the axial stop block 11 is 0.5 mm away from the pre-tensioning spring leaves 6.

In a preferred implementation of this embodiment, the method for installing the vertically-oriented lens assembly may further include a step S8 in which both the adjusting screw 10 and the tightening screw 8 are adhesively fixed to prevent the loosening of the adjusting screw 10 and/or the tightening screw 8, which may impair the stability of the vertically-oriented lens assembly. For example, the tightening screw 8 may be adhesively fixed after the tightening screw 8 is screwed about 0.1 mm.

In a preferred implementation of this embodiment, the method for installing the vertically-oriented lens assembly may further include a step of selecting the elastic support 4 according to the gravity G of the optical lens 2. The selected elastic support 4 should ensure sufficient supporting force and compressibility of the elastic support, so that the gravity of the optical lens is evenly distributed on the two rigid supports 7 and the elastic support 4. That is, each of the rigid supports 7 and the elastic support 4 is configured to be subject to a force equal to ⅓ of the gravity G. The degree of compression of the elastic support 4 may adjusted by tightening or loosening the adjusting screw 10 so as to change the force exerted on the optical lens 2.

In a preferred implementation of the embodiment 2, the method may further include a step of polishing the adjusting spacer 9 to adjust the tension provided by the pre-tensioning spring leaves 6.

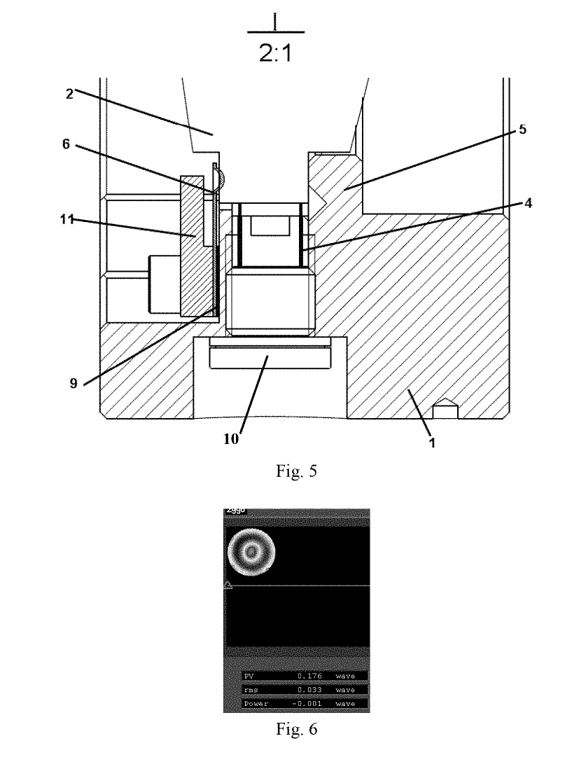

FIG. 6 shows data of a simulation experiment on surface variations that the lens will experience under the effect of its own gravity in an unassembled configuration.

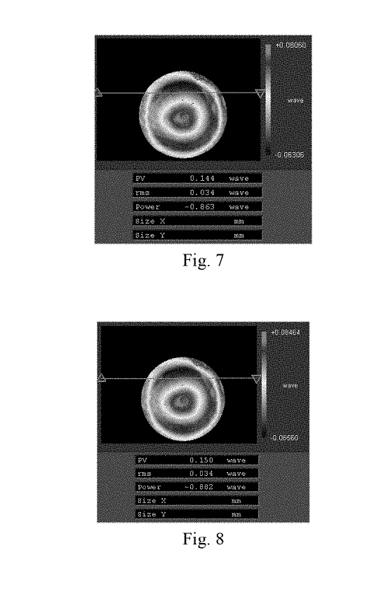

FIG. 7 shows data of a simulation experiment on minimum surface variations that the lens will experience under the effect of its own gravity when it is assembled in accordance with the present invention.

FIG. 8 shows data of a simulation experiment on maximum surface variations that the lens will experience under the effect of its own gravity when it is assembled in accordance with the present invention. As can be seen from the simulated data in FIGS. 6 to 8, when vertically assembled in accordance with the present invention, the optical lens 1 will have a peak-to-valley (P-V) value of smaller than 0.1 Fr in its effective area, indicating good uniformity and a high surface precision. The P-V value measures the difference between the “highest” and “lowest” parts on the surface of the lens, while Fr is a measure of interference fringes observed during lens surface measurements. As 1 Fr typically corresponds to 0.5 waves, the “<0.1 Fr” difference between surface variations of the unassembled and assembled configurations is equal to an amount of “<0.05 waves”.

The present invention is not limited to the particular embodiments disclosed herein. Any and all changes made without departing from the spirit of the invention fall within the scope thereof.

1. A vertically-oriented lens assembly, comprising a lens frame oriented vertically and an optical lens retained vertically in the lens frame, the vertically-oriented lens assembly further comprising: two rigid supports that are symmetric to each other with respect to a vertical central axis of the lens frame, both integral with the lens frame, both disposed under a horizontal central axis of the lens frame and both in direct contact with the optical lens; an elastic support right under the optical lens, the elastic support being able to be brought into contact with the optical lens through adjustment of an adjusting screw penetrating through the lens frame from right under a bottom of the lens frame; and a tightening screw disposed right at a top of the lens frame for limiting a radial displacement of the optical lens.

2. The vertically-oriented lens assembly of claim 1, wherein the optical lens is fixedly attached to the lens frame by an adhesive dispensed from bores that penetrate through the lens frame, the bores being symmetrically distributed on both sides of the vertical central axis of the lens frame and arranged above the horizontal central axis of the lens frame.

3. The vertically-oriented lens assembly of claim 2, wherein two bores are present on both sides of the vertical central axis of the lens frame, and wherein the two bores are oriented with respect to each other at an angle ranging from 30° to 170°.

4. The vertically-oriented lens assembly of claim 1, wherein the two rigid supports are symmetrically distributed on both sides of the vertical central axis of the lens frame and are oriented with respect to each other at an angle ranging from 30° to 120°.

5. The vertically-oriented lens assembly of claim 1, further comprising a clamping support mechanism for offsetting an axial displacement of the optical lens.

6. The vertically-oriented lens assembly of claim 5, wherein the clamping support mechanism comprises at least one pre-tensioning spring leaf and a rigid supporting member disposed on each side of a bottom of the optical lens.

7. The vertically-oriented lens assembly of claim 6, wherein the clamping support mechanism further comprises an adjusting spacer disposed between the optical lens and the pre-tensioning spring leaf.

8. The vertically-oriented lens assembly of claim 6, wherein an axial stop block for limiting the axial displacement of the optical lens is provided on a side of the pre-tensioning spring leaf facing away from the optical lens.

9. The vertically-oriented lens assembly of claim 6, wherein the rigid supporting member is disposed on one side right under the lens frame.

10. A method for installing the vertically-oriented lens assembly of claim 1, comprising the steps of:
S1) vertically orienting a lens frame;
S2) vertically disposing an optical lens on rigid supports of the lens frame;
S3) applying a force that equals a magnitude of gravity of the optical lens to the optical lens via a tightening screw, making each of the rigid supports abut the optical lens to limit a radial displacement of the optical lens;
S4) adjusting, with aid of a force gauge, a supporting force provided by an elastic support, such that the elastic support supports the optical lens with a supporting force equal in magnitude to ⅓ the gravity of the optical lens, and then locking an adjusting screw;
S5) attaching at least one pre-tensioning spring leaf, measuring a tension force produced by the at least one pre-tensioning spring leaf and making the tension force equal in magnitude to ⅔ the gravity of the optical lens;
S6) dispensing an adhesive through bores to fixedly attach the optical lens to the lens frame; and
S7) attaching an axial stop block.

11. The method for installing the vertically-oriented lens assembly of claim 10, further comprising a step S8) of adhesively fixing the adjusting screw and the tightening screw, thereby preventing loosening of the adjusting screw and/or the tightening screw.

12. The method for installing the vertically-oriented lens assembly of claim 10, further comprising a step of selecting the elastic support according to the gravity of the optical lens to ensure sufficient supporting force and compressibility of the elastic support, so that the gravity of the optical lens is evenly distributed on the two rigid supports and the elastic support.

13. The method for installing the vertically-oriented lens assembly of claim 10, further comprising a step of polishing an adjusting spacer and disposing the adjusting spacer between the optical lens and the pre-tensioning spring leaf in order to adjust the tension force provided by the pre-tensioning spring leaf.
